(19) United States
(12) Patent Application Publication
(10) Pub. No.: US 2006/0110022 A1
(43) Pub. Date: May 25, 2006

(54) Automatic image contrast in computer aided diagnosis

(76) Inventors: Daoxian H. Zhang, Los Gatos, CA (US); Yang Zheng, San Jose, CA (US)

Correspondence Address: Pamela R. Crocker;Patent Legal Staff, Eastman Kodak Company, 343 State Street, Rochester, NY, 14650-2201, US

(21) Appl. No.: 11/285,231

(22) Filed: Nov. 22, 2005

Related U.S. Application Data
(60) Provisional application No. 60/631,156, filed on Nov. 24, 2004.

(51) Int. Cl. G06K 9/00

(52) U.S. Cl. 382/132; 382/169; 382/274

(57) ABSTRACT

A method for adjusting contrast level for displaying an image, particularly for computed aided diagnosis. The method includes the steps of: masking one or more portions of the image to obtain a cropped image; forming a histogram of pixel intensity values from the cropped image using a plurality of bins, each bin having a predetermined bin width; designating one or more bins as image background bins and mapping pixels in the image background bins to a display background value; designating bins for upper and lower bound values and mapping tissue bins, having values between upper and lower bound values, to tissue display values, forming a contrast-adjusted image thereby; assigning pixels along the contour of the cropped image to one or more skin line bins; mapping pixels in the one or more skin line bins to an enhanced pixel value in the contrast-adjusted image; and displaying the contrast-adjusted image.

### RELATED APPLICATIONS

Reference is made to, and priority is claimed from, U.S. Provisional Application No. 60/631,156, entitled “AUTOMATIC IMAGE CONTRAST IN CAD APPLICATION”, filed on Nov. 24, 2004 in the names of Zheng et al, and which is assigned to the assignee of this application, and incorporated herein by reference.

### FIELD OF THE INVENTION

The present invention generally relates to medical image analysis and more particularly relates to an automated method for setting contrast level for display and analysis of a medical image.

### BACKGROUND OF THE INVENTION

The benefits of computer-aided diagnosis in radiology in general, and particularly in mammography, are widely recognized. There has been efforts directed toward computer-aided methods that assist the diagnostician to correctly and efficiently identify problem areas detected in a mammography image and to improve the accuracy with which diagnoses are made using this information.

In mammography, it is recognized that early detection of microcalcification structures in the breast can help to diagnose cancer in early stages where treatment offers more hope of success than at more advanced stages. Research shows that calcifications are typically formed from various salts of calcium, magnesium, or phosphorus collected within the breast as a result of secretions within structures that have become thickened and dried. Microcalcification (abbreviated as MCC) structures tend to take the shape of the cavity in which they form so that analysis of their morphology, density, size, and distribution can help determine whether they are benign or malignant.

Calcification structures are detected in X-ray images of the breast, which are provided as digital data for analysis and assessment. Various calcification attributes can be extracted from this data and used to distinguish benign from suspected malignant calcifications. Benign calcifications tend to appear as single spots (rather than clusters) and have a regular shape, while malignant calcifications most often appear in clusters of spots and are of irregular shapes.

Among the characteristics employed by diagnosticians in working with x-ray images of the breast, the following guidelines can be considered:
Large (>1 mm diameter), coarse calcifications are likely to be benign, but malignant MCCs tend to be punctuate, 0.5 mm or smaller;
Single calcifications are more likely to be benign;
Rounded calcifications of equal size are likely to be benign;
Calcifications scattered through both breasts are more likely to be associated with benign disease;
Groups of calcifications of mixed size with irregular shapes are more characteristic of malignant than benign condition;
Clusters of fine calcifications are more likely to signify malignancy;
Rows of fine calcifications within the ducts are likely to signify malignancy;
Short rods of calcification, particularly if they branch, are highly likely to signify malignancy;
Grossly irregular whorled cluster shapes are likely to signify malignancy;
In malignant calcification clusters, the average distance between calcifications is typically less than 1 mm.

Employing these characteristics, image analysis methods used in Computer Aided Diagnostics (CAD) systems extract and quantify image data relating to shape, edge character, and intensity at both the spot and cluster level. The shape can be characterized according to its geometric features such as compactness, perimeter, elongation, ratio of moments, and eccentricity. The edge character shows the comparison of the calcification with its background, which can be analyzed by the gradient of the spot boundary and the contrast between the spot and the background. The intensity-based features of the calcification include the mean intensity of a spot as well as the maximum intensity, the deviation of the intensity, the moment, and the like.

The results of CAD analysis serve as an aid to the diagnostician, assisting to highlight areas of particular interest and to eliminate areas that are not suspicious.

In the literature, some standard abbreviations or acronyms are used in the discussion of mammography accuracy, including:
FP—False Positive, an error in which a benign structure is incorrectly identified as malignant;
FN—False Negative, an error in which a malignant structure is incorrectly identified as benign;
TP—True Positive, a result in which a malignant structure is correctly identified;
TN—True Negative, a result in which a benign structure is correctly identified.

Microcalcifications can be subtle in appearance. A number of factors can adversely influence the percentage of correct results obtained from the CAD system. Errors can result from factors such as poor image quality, improper positioning of the patient, film variations, scanner performance, obscuration from fibroglandular tissue, and other problems. Because of these difficulties, some view the success rate in correctly identifying and diagnosing microcalcification structures as disappointing.

Some proposals have been made for improving the accuracy of diagnosis for microcalcification detection and classification.

U.S. Pat. No. 4,907,156 entitled “Method And System For Enhancement And Detection Of Abnormal Anatomic Regions In A Digital Image” to Doi et al. is directed to the use of a local gray level threshold that varies with the standard deviation of surrounding pixel values for isolating microcalcifications.

U.S. Pat. No. 5,999,639 entitled “Method and System for Automated Detection of Clustered Microcalcifications from Digital Mammograms” to Rogers et al. relates to a detection and classification sequence including automatic image cropping, filtering including use of a difference of Gaussian filtering enhancement, clustering, and feature computation

U.S. Pat. No. 5,537,485 entitled “Method for Computer-Aided Detection of Clustered Microcalcifications from Digital Mammograms” to Nishikawa et al. describes a cluster filtering method using successively applied thresholds to isolate suspected malignant calcifications from benign structures.

An article entitled “Local contrast enhancement for the detection of microcalcifications” in Proc 5^{th} Int. Workshop Digital Mammography, pp. 598-604, 2000 by H. Neiber, T. Muller, R. Stotzka describes the use of a local threshold for identifying microcalcification structures, dependent on the difference between local maximum and mean gray levels.

While such methods may have achieved certain degrees of success in their particular applications, there is still need for improvement. The percentage of false negative (FN) and false positive (FP) errors is still too high when using conventional CAD systems. Proposed solutions have often tended to focus on ever more sophisticated image processing algorithms for reducing FN and FP errors. However, even using advanced neural networks and other powerful image analysis and decision-making tools may only provide incremental improvement over existing methods.

In addition to automated detection of microcalcifications, the CAD system also provides images for visual assessment by the diagnostician. One problem of particular interest for accurate diagnosis and optimized image display is the need for a suitable adjustment in image contrast. Image contrast, generally characterized in terms of the ratio of the intensity of an image feature to the intensity of the background, can easily vary from one image to the next, based on factors such as patient tissue characteristics, intermediate image processing steps including film development and scanning for some systems, image exposure conditions, and system calibration, for example. Some CAD systems address the problem of contrast adjustment by requiring the operator to make adjustments using operator interface tools such as slider bars and the like. When the operator is satisfied that the contrast adjustment is optimized, the image can then be viewed and diagnosis attempted.

As one example, U.S. Pat. No. 6,463,181 entitled “Method for Optimizing Visual Display of Enhanced Digital Images” to Duarte describes a graphical user interface (GUI) that allows a physician to select from various image enhancement methods and to view various image segments having different image processing treatments. As described, the viewing physician must make various tradeoffs between one type of image treatment or level of image treatment and another in order to obtain the desired processing for an image. Such a system requires some training for its proper use.

Not all image processing is advantageous for contrast and other characteristics. Thus, even where adjustments are “easy to use” from a GUI perspective, there can be disadvantages and problems when these features are not used well.

While some systems have employed adjustment utilities and techniques for the adjustment task, there is still considerable dissatisfaction with the adjustment task and with its outcome. Some practitioners dislike the job of manually adjusting image contrast and find the various contrast adjustment tools confusing, using only a portion of the interface as a result. Providing more complex, capable tools may improve potential accuracy but may not be well accepted by medical professionals, particularly those trained on earlier equipment where contrast, from one image to the next, had been relatively constant for images from the same imaging system.

One problem with applying conventional image contrast adjustment techniques to mammography images is that specific details needed by the diagnostician may be lost. In particular, skin line details, which may be very faint after contrast adjustment, are important for the establishment of reference points. For example, a contour feature such as a nipple outline may be very important for providing a reference location. This complicates the task of contrast adjustment, whether done manually by the imaging system operator or performed automatically for an image.

Thus, there exists a need for a more accurate automated method for making a suitable contrast adjustment in a medical image.

### SUMMARY OF THE INVENTION

It is an object of the present invention to provide a method for adjusting contrast level for displaying an image. The method comprises the steps of: (a) masking one or more portions of the image to obtain a cropped image; (b) forming a histogram of pixel intensity values from the cropped image using a plurality of bins, each bin having a predetermined bin width; (c) designating one or more bins as image background bins and mapping pixels in the image background bins to a display background value; (d) designating bins for upper and lower bound values and mapping tissue bins, having values between upper and lower bound values, to tissue display values, forming a contrast-adjusted image thereby; (e) assigning pixels along the contour of the cropped image to one or more skin line bins; (f) mapping pixels in the one or more skin line bins to an enhanced pixel value in the contrast-adjusted image; and (g) displaying the contrast-adjusted image.

The present invention provides skin line enhancement as part of contrast enhancement.

These and other objects, features, and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

While the specification concludes with claims particularly pointing out and distinctly claiming the subject matter of the present invention, it is believed that the invention will be better understood from the following description when taken in conjunction with the accompanying drawings, wherein:

FIG. 1A is a graph showing a lift function for skin line pixel enhancement.

FIG. 1B is a graph showing histogram curves before and after skin line pixel enhancement.

FIG. 2 shows an example image display without automatic contrast enhancement.

FIG. 3 shows an example image display with automatic contrast enhancement according to the present invention.

FIG. 4 is a logic flow diagram showing processing steps for automatic contrast enhancement according to the present invention.

### DETAILED DESCRIPTION OF THE INVENTION

The present description is directed in particular to elements forming part of, or cooperating more directly with, apparatus in accordance with the invention. It is to be understood that elements not specifically shown or described may take various forms well known to those skilled in the art.

The method of the present invention can use hardware and software components, but is independent of any particular component characteristics such as architecture, operating system, or programming language, for example. In general, the type of system equipment that is conventionally employed for scanning, processing, and classification of mammography image data, or of other types of medical image data, is well known and includes at least some type of computer or computer workstation, having a logic processor which may be dedicated solely to the assessment and maintenance of medical images or may be used for other data processing functions in addition to image processing. Typically, results display on a monitor screen or, optionally, results may be printed. Characteristics such as processing speed, memory and storage requirements, networking and access to images, and operator interface, for example, would be suitably selected for the image analysis function and the viewing environment, using practices and guidelines that are well known in the medical image processing arts.

The method of the present invention provides an automatic adjustment of image contrast for views taken during mammography. Typically, two views are taken, along cranio-caudal (CC) and mediolateral oblique (MLO) planes. Except as specifically noted, the methods of the present invention can be applied to either or both CC and MLO views and, more generally, to other types of medical image capable of showing microcalcifications or other internal structures of interest.

The method of the present invention is particularly advantaged for mammography imaging, providing special treatment of skin line features so that contrast of this key image reference characteristic is maintained at suitable levels while contrast of other portions of the image is adjusted.

As noted in the background section, linear adjustment of pixel intensity is not well adapted to the task of improving image contrast in mammography imaging. While some features may be accentuated at a particular setting, other key image features, most notably skin-line features, can be lost when linear adjustment is performed. Instead, the method of the present invention em ploys a non-linear mapping of pixel intensities in order to selectively adjust the dynamic range of the mammography image, using a Look-Up Table (LUT) or other type of non-linear mapping mechanism that is automatically generated.

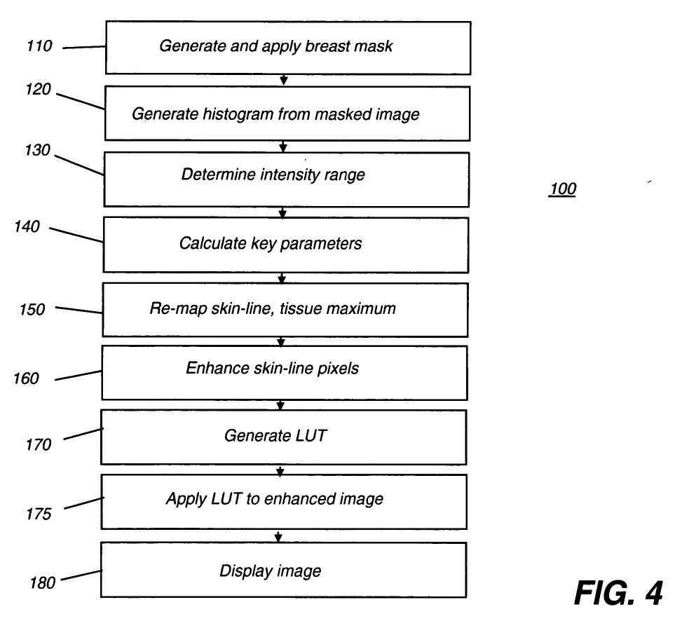

Referring to FIG. 4, there is shown a logic flow diagram of the overall steps for image contrast enhancement in a contrast enhancement procedure 100 according to the present invention. This procedure begins with a breast mask generation and application step 110, with the purpose of obtaining the set of pixels corresponding to the tissue of interest. In step 110, image processing is used to generate one or more masks for the breast outline, including the pectoral muscle area. Known artifacts may also be masked in this step. The resulting masked image is cropped to the breast mask outline, thereby isolating the area of interest from the full mammography image. In this way, areas outside the breast contour are effectively eliminated from the image data to be processed, so that only tissue portions of the image are used. Foreign objects, known benign calcifications, or other artifacts can be effectively masked to remove them from the image data of interest.

Statistical data can be gathered from pixels that represent tissue in the resulting cropped image. A histogram is first generated, using the intensities of pixels in the cropped image in a generate histogram step 120. As part of conventional histogram generation, a grouping or partitioning procedure is executed, which reduces the resolution of the image data but makes it more manageable and reduces undesirable noise effects. For an image having a bit depth of 16 bits, there are 65,536 possible data levels, from 0 to 65535. Reducing this large number of data levels to a predetermined number of groupings, by intensity level, makes the data more easily manageable. This grouping procedure reduces this resolution by assigning values within a range to a class or “bin”, as the term is commonly used with respect to histogram generation. A count for each bin is maintained, with a counter for a specific bin incremented each time a value in the range associated with that bin is encountered. With this type of partitioning, ranges for the respective histogram bins are adjacent and non-overlapping and span equal intervals of data value increments, that is, have the same bin width. Each data value is assigned to one and only one bin. A bin number is assigned and then used for the image processing operations that follow. For example, in an embodiment with an image having 16-bit resolution, 64 bins are used, each bin having a bin width of 1024 bits. For any particular embodiment, the bin width, or alternately, the number of bins, can be selected empirically, applying standard approaches to histogram design. Alternately, the bin width can be computed using statistical data, following methods well known in the mathematical arts.

The next set of steps is used for properly assigning pixels to the various histogram bins and for remapping pixel intensity values once the pixels have been assigned. In an intensity range determination step 130 the upper and lower bounds for pixels in the cropped image are established. A calculate key parameters step 140 follows, in which a number of calculations and adjustments are performed. For example, a level for intensity for a background bin is determined, so that all pixels having intensities at or below this value are considered as background. The relative pixel intensity level that is suitable as background bin could be set empirically or could be determined using statistical values from the image. For example, a background bin value of 6 may be used in one embodiment. Any pixel grouped at or below this bin value is a background pixel. The background bin is then mapped to zero or other minimum intensity value, establishing a baseline for the contrast adjustments that follow. The threshold level for this background setting can be determined empirically or may be calculated using statistical data obtained from the cropped image.

Using the breast mask that was generated previously in breast mask generation and application step 110, one or more skin line bins is allocated. The breast mask, generated using pattern recognition algorithms or other techniques such as the skin line detection technique disclosed in U.S. Application Publication No. 2002/0181797 entitled “Method for Improving Breast Cancer Diagnosis Using Mountain-View and Contrast-Enhancement Presentation of Mammography” by Young, closely follows the skin line feature. Values of skin line pixels located using the breast mask can then be assigned to the skin line bin or bins. This grouping will be used in subsequent processing in order to accentuate skin line features, since these features are particularly useful to the diagnostician, as was noted earlier. Skin line features are particularly troublesome for conventional image processing because these are typically darker than the rest of the breast tissue and can easily be lost as part of image background data.

Image pixels not assigned to either the background or skin line bins are appropriately distributed, according to intensity value, among the other histogram bins that are used for internal tissue image values. Other calculations performed as part of step 140 include obtaining the first derivative of the histogram and calculating statistical values such as mean, standard deviation, and maximum intensity values for the breast tissue.

In a re-mapping step 150, skin line and other internal tissue pixel values are re-mapped using rule-based logic. Re-mapping of skin line values is performed by reserving some portion of the image level function, that is, some range of one or more bin values, exclusively for skin line content. This might affect the luminance range that is available for the balance of breast tissue. However, since it is possible to identify the skin line features with some accuracy using the breast mask as a guideline, treating these features separately in order to accentuate the skin line can be performed without a noticeable loss of image dynamic range and allows the viewer to take advantage of a more clearly defined breast profile than is available without special treatment or is available when skin line pixels receive the same treatment as other internal tissue pixels. In one embodiment, where the tissue maximum value is normalized to 1.0, the skin line value is mapped to 0.13.

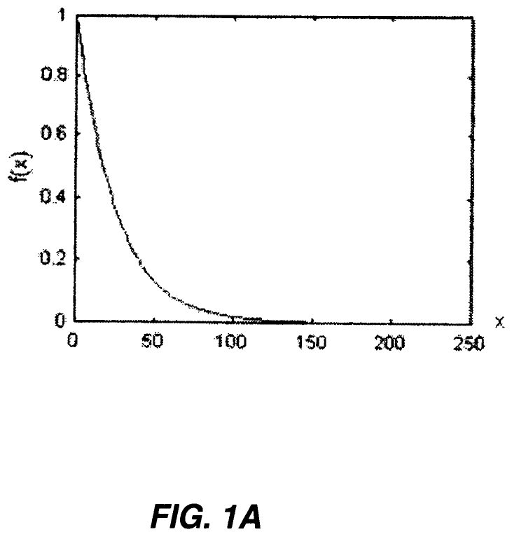

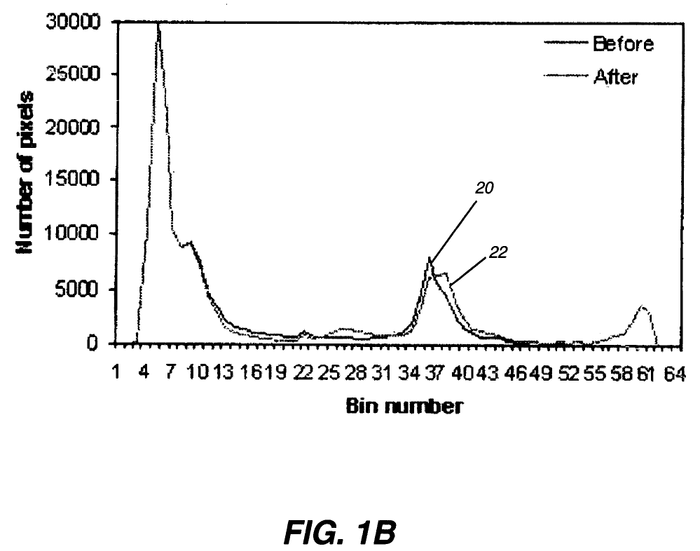

An enhance skin line step 160 follows, in which pixels within the bin or bins assigned to skin line areas are adjusted using a partial “lift” function. In one embodiment, the following lift function is employed:
f(x)=Ie^{-0.4x}
where I is a constant estimated as the intensity difference between the lower bound of the skin line and the lower bound of the inner breast tissues. The graph of FIG. 1A shows the behavior of this lift function. The exponential factor causes a rapid decline in intensity from a maximum value, normalized to 1.0 as shown in FIG. 1A. Applying this type of function to pixels in the skin line area provides a highlight of the skin line features that makes a smooth transition between skin line and inner tissue features. As shown in the graph of FIG. 1B, using this type of image processing, selective for a narrow range of values reserved for a key outline feature, has only minor, somewhat localized impact on the image histogram. A curve 20 indicates the image histogram, grouped in 64 bins as described earlier, before skin line enhancement. A second curve 22 traces the histogram following skin line enhancement.

The results of enhance skin line step 160 and the preceding calculations are used to generate a Look-Up Table (LUT) that provides a remapping of pixel values that is typically non-linear. In an LUT generation step 170, a non-linear mapping function is generated, based on the results of preceding steps 140, 150, and 160. The non-linear mapping function can be piece-wise linear, piece-wise non-linear, or with some combination of linear and non-linear portions. Each portion of the non-linear mapping maps various intensity values in the data to re-mapped intensity values, obtaining improved image contrast thereby. A tissue range is determined, with an upper bound and a lower bound, wherein both the upper bound and the lower bound correspond to one or more histogram bins. Pixels in the bins for internal tissue, bounded by the upper and lower bounds, can then be suitably remapped for forming a contrast-adjusted image. An LUT or other type of indexed data structure is generated for storing the results of this re-mapping process.

In a LUT application step 175, the generated LUT that has been formed using the above procedure is then applied to the skin-line enhanced image, including areas outside of the breast mask. In a display step 180, the resulting enhanced mammography image having optimized contrast is displayed or can be printed.

The LUT that is generated and used in contrast enhancement procedure 100 provides skin line enhancement along with overall contrast enhancement of the balance of the mammography image. Non-linear mapping using an LUT enables image processing logic to increase the dynamic range of the image data, thereby improving contrast.

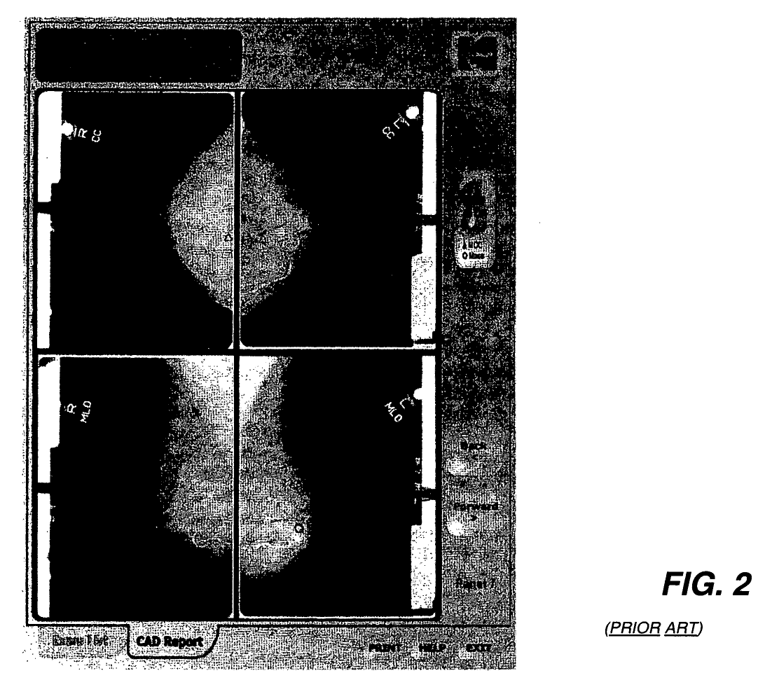

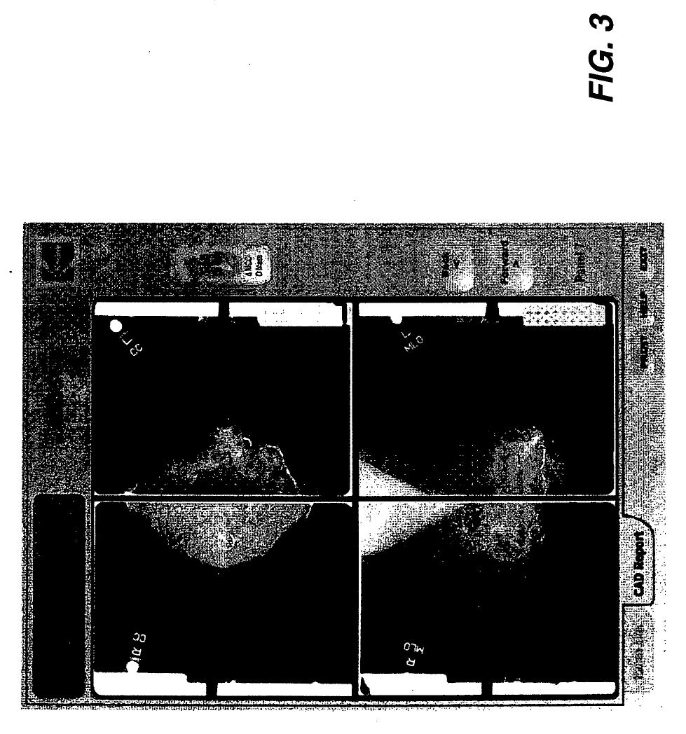

FIG. 2 shows prior art mammography images without the application of contrast enhancement procedure 100. FIG. 3 shows the same images after contrast enhancement procedure 100 is applied. Markers 24 can be added to the images following contrast enhancement processing. Hollow markers 24 would be preferred, since these highlight key features identified in the image for further assessment without obstructing portions of the highlighted features.

The invention has been described in detail with particular reference to certain preferred embodiments thereof, but it will be understood that variations and modifications can be effected within the scope of the invention as described above, and as noted in the appended claims, by a person of ordinary skill in the art without departing from the scope of the invention. For example, histogram processing can be performed in a number of ways, including using bin widths of various dimensions.

### PARTS LIST

20, 22. Curve
24. Marker
100. Contrast enhancement procedure
110. Breast mask generation and application step
120. Generate histogram step
130. Intensity range determination step
140. Calculate key parameters step
150. Re-mapping step
160. Enhance skin line step
170. LUT generation step
175. LUT application step
180. Display step

1. A method for adjusting contrast level for displaying an image, the method comprising the steps of:
(a) masking one or more portions of the image to obtain a cropped image;
(b) forming a histogram of pixel intensity values from the cropped image using a plurality of bins, each bin having a predetermined bin width;
(c) designating one or more bins as image background bins and mapping pixels in the image background bins to a display background value;
(d) designating bins for upper and lower bound values and mapping tissue bins, having values between upper and lower bound values, to tissue display values, forming a contrast-adjusted image thereby;
(e) assigning pixels along the contour of the cropped image to one or more skin line bins;
(f) mapping pixels in the one or more skin line bins to an enhanced pixel value in the contrast-adjusted image; and
(g) displaying the contrast-adjusted image.

2. The method of claim 1, wherein the step of masking one or more portions of the image comprises applying a breast mask.

3. The method of claim 1, wherein the step of mapping pixels in the one or more skin line bins to an enhanced pixel value comprises computing the enhanced pixel intensity value using an exponential factor.

4. The method of claim 1, wherein the contrast-adjusted image comprises the cropped image and at least portions of the image masked in step (a).

5. The method of claim 1, wherein the image is a mammography image.

6. A method for forming a non-linear mapping function for a medical image, the method comprising the steps of:
(a) obtaining a plurality of image pixels for living tissue, wherein each image pixel has a corresponding pixel intensity value;
(b) forming a histogram according to the obtained pixel intensity values, using a predetermined histogram bin width;
(c) assigning image pixels to bins by:
(i) assigning a portion of image pixels having low pixel intensity values to at least one background bin;
(ii) assigning image pixels located along a skin surface to at least one skin line bin; and
(iii) assigning other image pixels, not assigned to background or skin line bins, to bins for internal tissue image values;
(d) remapping the image pixel intensity values according to the bin assignment of step (c) by:
(i) mapping each background bin pixel to a minimum pixel intensity value;
(ii) mapping each skin line bin pixel to an enhanced skin line pixel intensity value; and
(iii) mapping each pixel in the bins for internal tissue image values to one of a range of remapped pixel intensity values spanning a minimum and maximum value; and
(e) forming an indexed data structure storing the minimum, enhanced skin line, and remapped pixel intensity values.

7. The method of claim 6, wherein the step of obtaining pixel intensity values further comprises forming a mask according to a detected outline of a breast.

8. The method of claim 6, wherein the step of mapping pixels in the bins for tissue image values further comprises normalizing pixel values according to a maximum pixel intensity value.

9. The method of claim 6, wherein the step of forming an indexed data structure comprises forming a look-up table.
